(19) United States
(12) Patent Application Publication
(10) Pub. No.: US 2005/0012890 A1
(43) Pub. Date: Jan. 20, 2005

(54) Universal glare and safety shield

(76) Inventor: Anthony Iacobucci, Amesbury, MA (US)

Correspondence Address: Dauphin Law Offices;Suite 365, 9 Bartlett Street, Andover, MA, 01810, US

(21) Appl. No.: 10/891,896

(22) Filed: Jul. 14, 2004

Related U.S. Application Data
(60) Provisional application No. 60/486,971, filed on Jul. 14, 2003.

(51) Int. Cl. G02C 7/10; G02C 11/08

(52) U.S. Cl. 351/44

(57) ABSTRACT

A universally attachable glare and safety shield for eyewear that prevents or limits light and or debris from interfering with the wearer wherein the shield includes one or more shapeable or adjustable members with attachment means for adaptively connecting to a variety of eyewear designs.

### FIELD OF THE INVENTION

The present invention is directed generally to eyewear and more particularly to a universally attachable glare and safety shield for attaching thereto.

### BACKGROUND OF THE INVENTION

Presently, there are several prior art solutions for reducing glare in the use of eyeglasses, sunglasses and other eyewear. Certain drawbacks exist with these systems. For example, certain eyewear employ frames with extremely wide temples to block glare entering from the through the sides of the eyewear. Unfortunately, these eyewear frame systems also block the wearer's peripheral vision. Other glare blocking systems employ expensive rounded frame shapes, which curve around the wearer's eyes to block glare.

In addition to the functionally shaped prior art eyewear frames, there are several known devices or systems for reducing glare and debris that will attach to a conventional eyewear. Certain drawbacks exist with these systems. For example, several of these systems will block glare and debris but also limit the wearer's peripheral vision. Other systems are functional but will only fit certain eyewear shapes and sizes, are difficult to

None of the prior art devices provide a design that reduces glare or debris without limiting peripheral vision, and which is universally attachable and inexpensive.

Accordingly, there is a well-established need for a glare shield system that avoids the drawbacks and limitations of the prior art. In particular, it would be desirable to provide a glare shield that is flexible and adaptable to fit a wide range of frame sizes and shapes while being discrete, stylish, self-adjusting to fit many different eyeglass types, universally attachable, reusable and inexpensive.

### SUMMARY OF THE INVENTION

It is therefore an object of the present to provide a glare shield system that avoids the problems associated with prior art glare prevention systems.

It is another object of the present invention to provide a glare shield apparatus that is flexible while being discrete.

It is a further object of the present invention to provide a glare shield apparatus that is stylish.

It is yet another object of the present invention to provide a glare shield apparatus that is self-adjusting to fit many different eyeglass types.

It is still yet a further object of the present invention to provide a glare shield apparatus that is universally attachable.

It is still yet a further object of the present invention to provide a glare shield apparatus that is inexpensive.

Other objects will, in part, be obvious and will, in part, appear hereinafter. The invention accordingly, comprises the features of construction, combination of elements and arrangements of parts, which will be exemplified in the following detailed description and the scope of the invention will be indicated in the claims.

According to one aspect of the invention, a shield for limiting eye exposure to glare and debris, adapted for use with an eyewear frame having a pair of temple arms, said shield comprises a moldable structure adapted for molding to and maintaining a general shape of the eyewear frame and at least one attachment means operatively connected to said moldable structure for releasably coupling the moldable structure to at least of the temple arms.

As to another aspect of the invention, the moldable structure further comprises a flexible material frame.

As to another aspect of the invention, the flexible material is semitransparent, opaque with perforations and or translucent.

As to yet another aspect of the invention, the moldable structure includes a leading edge designed to follow the contours of the eyewear frame and a trailing edge designed to follow the contours of the wearer's face.

As to another aspect of the invention, the moldable structure further includes means for molding and maintaining the shape of the shield.

As to another aspect of the invention, the means for molding and maintaining the shape of the shield is a wire or plastic member.

As to yet a further aspect of the invention, the attachment means includes at least one o-ring adapted for slidably engaging a temple arm, at least one pliable tubular guide adapted for slidably engaging a temple arm, at least one clip and or at least one adjustable strap.

As to yet a further aspect of the invention, the at least one pliable tubular guide further comprises a rubberized lining.

Another aspect of the invention is directed to a shield for limiting eye exposure to glare and debris, adapted for use with an eyewear frame having a pair of temple arms, a pair of lenses and an outer periphery generally defined by a perimeter immediately adjacent and surrounding the pair of lenses, in which the shield comprises a moldable structure adapted for molding to and maintaining a general shape of said outer periphery wherein the moldable structure is designed to operatively bridge an opening between the eyewear frame and the face of the eyewear user and wherein the moldable structure further includes at least one attachment means operatively connected to said moldable structure for releasably coupling the moldable structure to the eyewear frame.

As to another aspect of the invention, the at least one attachment means comprises a pliable tubular guide operatively constructed and positioned to slide over a temple arm.

As to another aspect of the invention, the moldable structure further includes means for molding and maintaining the shape of the shield.

As to yet another aspect of the invention, the means for molding and maintaining the shape of the shield includes a wire operatively connected to said moldable structure.

As to another aspect of the invention, the moldable structure comprises a plurality of operatively connectable pieces adapted for providing adjustability to the shape and size of the moldable structure.

As to another aspect of the invention, two or more of the plurality of operatively connectable pieces are connected by Velcro.

According to yet another aspect of the invention a universal glare and safety shield adapted for use with an eyewear frame comprises a shapeable member adapted for molding to and maintaining a general binocular shape corresponding to the shape of the eyewear frame, the shapeable member further comprises a plurality of adjustable attachment means for removably coupling the shapeable member to the eyewear frame.

### BRIEF DESCRIPTION OF THE DRAWINGS

The preferred embodiments of the invention will hereinafter be described in conjunction with the appended drawings provided to illustrate and not to limit the invention, wherein like designations denote like elements, and in which:

FIG. 1 a perspective view showing a glare shield in accordance with a first embodiment of the present invention wherein the glare shield is shown attached to a representative eyeglass frame;

FIG. 2 is a side elevational view of the glare shield of FIG. 1;

FIG. 3 is top view of the glare shield of FIG. 1;

FIG. 4 is top view of a glare shield in accordance with another embodiment of the present invention;

FIG. 5 is a perspective view showing a glare shield in accordance with another embodiment of the present invention;

FIG. 6 is a perspective view showing a glare shield in accordance with another embodiment of the present invention;

FIG. 7 is a perspective view showing a glare shield in accordance with another embodiment of the present invention;

FIG. 8 is a perspective view showing a glare shield in accordance with another embodiment of the present invention attached to a representative eyeglass frame; and

FIG. 9 is a perspective view showing a glare shield in accordance with another embodiment of the present invention attached to a representative eyeglass frame.

### DESCRIPTION OF THE INVENTION

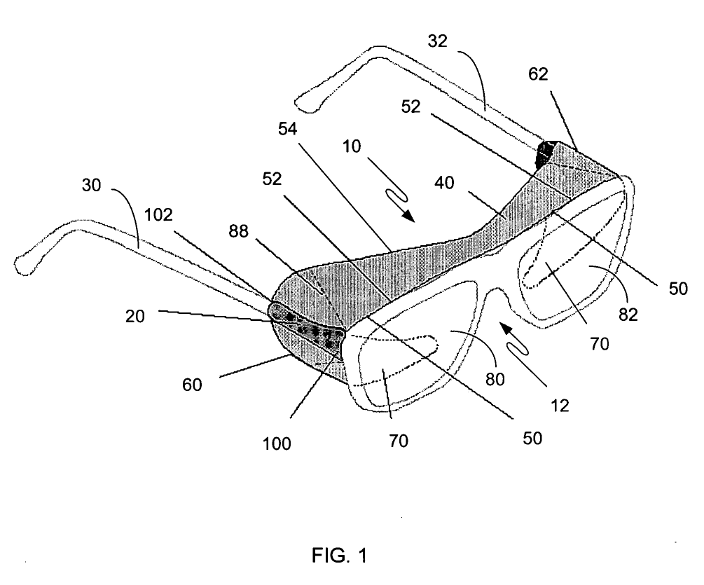

FIG. 1 shows a glare shield 10 that is removably attachable to an eyewear frame 12. In a preferred embodiment the glare shield 10 employs a transparent or see-through fabric that minimizes glare and reflections while allowing the wearer to continue to have peripheral vision, often a drawback with other similar systems. It should be noted that the term eyewear will be used to refer to all types of eyewear, including prescriptions eyeglasses, safety glasses, sunglasses and the like.

In certain embodiments of the present invention, the glare shield 10 includes attachment means for attaching to eyewear frame 12. For example, in the present embodiment, the attachment means include a pair of temple-guides 20, 22, which slide over a pair of eyewear temples 30, 32, respectively. As shown, the glare shield 10 includes a top member 40 that spans the distance between temples 30, 32. The top member 40 includes a leading edge 50 that preferably follows or forms to the upper contours 52 of the eyewear frame 12. The top member 40 further includes a trailing edge 54 that preferably follows or forms to the contours of the wearer's brow (not shown).

The glare shield 10, designed to follow the periphery of the eyewear frame 12, includes a pair of side panels 60, 62 that wrap around or behind temples 30, 32. In certain embodiments, the side panel 60, 62 continue wrapping around and underneath the eyewear frame 12 forming a pair of lower shield tabs 70, 72, for further glare and debris protection.

When attached to a pair of eyeglasses or sunglasses the glare shield 10 reduces glare emanating in a wearer's peripheral vision and reduces reverse reflections from the inner side of the eyeglass lenses 80, 82. Thus glare shield 10 improves vision by reducing contrast between the wearer's periphery and field of vision while blocking debris from passing between the eyewear and the wearer's eyes.

In the present embodiment, the temple-guides 30, 32 are designed to accommodate a variety of different shaped eyeglass and sunglass frames. Preferably, the temple-guides 30, 32 are formed from an elastic or otherwise adjustable material, which allows them to adjust to both large and small temples. In addition to allowing the glare shield 10 to be universally adaptable to several shapes and sizes of eyewear the elastic temple-guides 30, 32 also allow the glare shield 10 to be easily removed, re-used, swapped and or re-fit providing the same benefit on many different pairs of eyewear.

In certain embodiments, the glare shield may employ materials and shapes that are comfortable, functional and or stylish. For example certain materials may be used that wick away sweat from the user. In certain embodiments, the glare shield 10 includes a flexible frame made of metal or plastic. The flexible frame may be combined with a stretchable fabric body and a self-adhering temple-guide, which would allow it to stretch and form to the shape of the eyeglasses to which it is attached.

In other embodiments of the present invention, foam rubber may be employed as the main body material. Foam rubber would allow the main body to be flexible yet maintain its form. In addition, foam rubber or similar material would be comfortable to the touch as well as being translucent and washable. Also, this type of material would allow a glare shield that was crumpled up or folded to spring back into its intended shape. Additionally, foam rubber or similar materials may be used primarily for edging the glare shield. This would contribute to the glare shields style, comfort and durability.

In alternative embodiments, the glare-shield may be made of woven fabrics, thereby allowing it to be manufactured and fashioned into a variety of stylish formats, colors and patterns. In addition, the fabric may be durable which would allow it to be washed and re-used many times.

Several other design materials for the glare shield are contemplated. For example, materials that are flexible, translucent, portable, re-usable and or comfortable may be used such as semi-transparent cloth—Nylon, Lycra and other see through fabric materials; opaque cloth with perforations—Cotton, Wool, Nylon, Polyester, Silk; and other types of material with machine cut holes in patterns that allow light to pass a certain amount of light to pass through creating a translucent affect. In certain embodiments, the hole patterns may be cut into designs for style.

Still other combinations are contemplated such as using an opaque cloth with metal or plastic grommets, including stylish hole-patterns for creating a translucent and stylish affect and or employing a wire-mesh woven material such that the glare shield will maintains its shape and remaining translucent. Soft shell plastics are very flexible and translucent and other than the body material look and attach the same way as the fabric models. Metal sheeting that is foil-like with perforations would create a translucent shield that would look and attach the same way as the fabric models.

As discussed above, in certain embodiments, the glare-shield 10 is cut to follow the contour of the human face so to reduce glare from the peripheral vision. The shape of the glare shield may also be designed such that when it is attached to the eyewear, it stays within the physical limits of the eyeglass frame and falls out of view from the front view of the eyeglasses. In certain embodiments, the body of the glare-shield 10 is flexible and can be folded-up when the eyeglasses are removed. For certain models there are creases 88 pressed into the body material so it always folds at the same points keeping the glare-shield looking sharp and stylish.

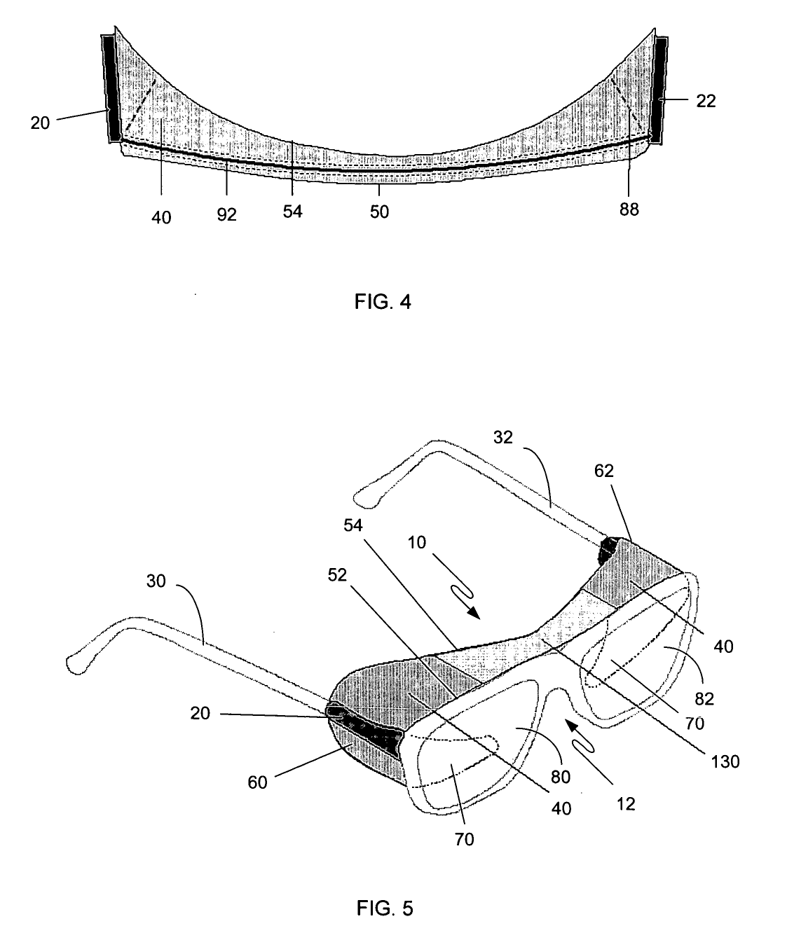

Referring now to FIG. 4, the glare shield includes a hemmed edge 90 and a stitched-into-the-hem moldable member 92 (comprised of a metal wire, moldable plastic or the like), which adds to the self-adjusting nature of the glare-shield and allows the glare shield to be molded into and maintain a binocular shape. Additionally the hem 90 can be slightly recessed from the leading edge 50 allowing further self-adjusting of the glare-shield. The present design makes the glare-shield follow the shape of the eyeglasses 12 creating a close fit with the eyeglasses.

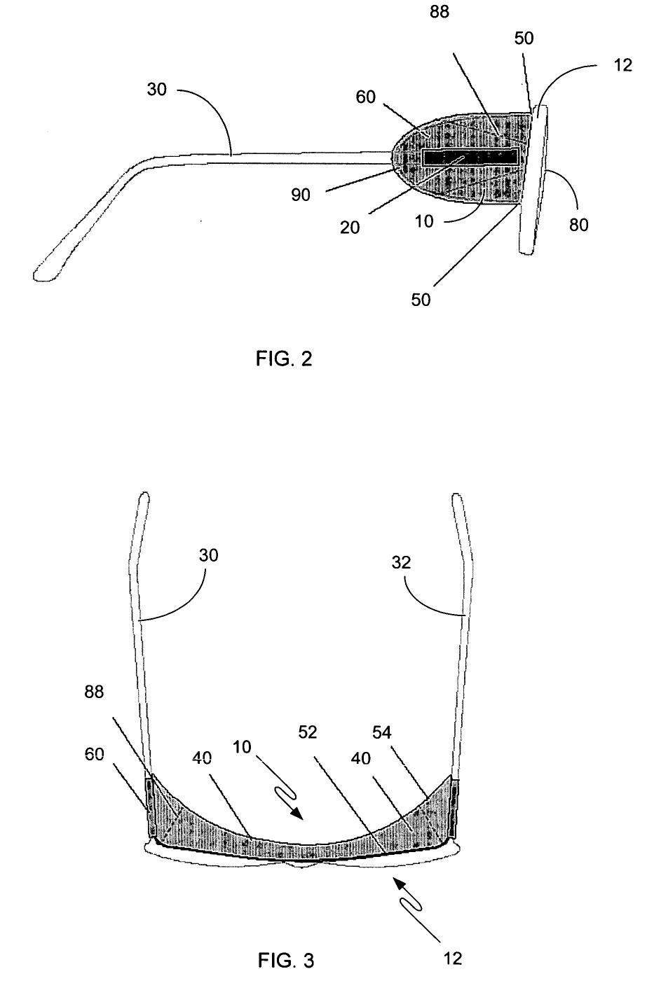

Several means for attaching the glare shield 10 to the eyewear frame 12 are contemplated. For example, as shown in FIGS. 1 through 7, the temple-guides 20, 22 can be slid over many different eyewear temples. The temple guides may be formed from a stitched fabric into a tubular form having a first opening 100 and a second opening 102, allowing for easy insertion over temples 30, 32 and providing a large surface area for securing the glare-shield 10 to the eyeglasses 12. For abnormally shaped eyeglasses that are very hard to fit there is a model of the glare-shield with a pliable tubular guide that affixes the glare-shield to the eyeglass temple.

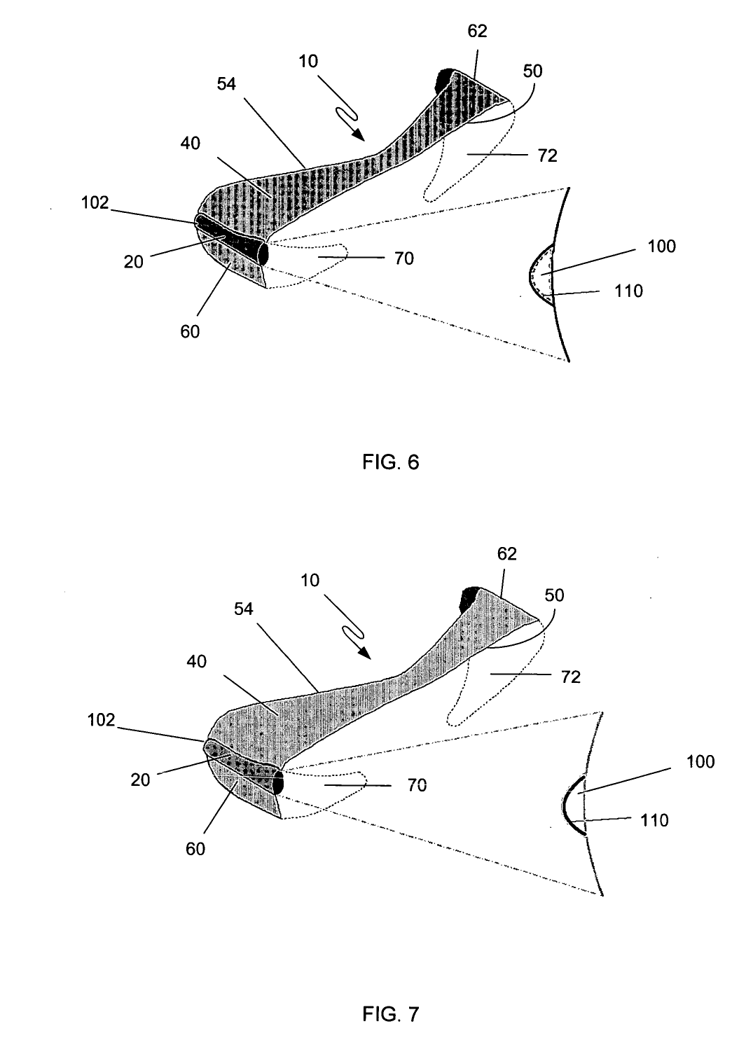

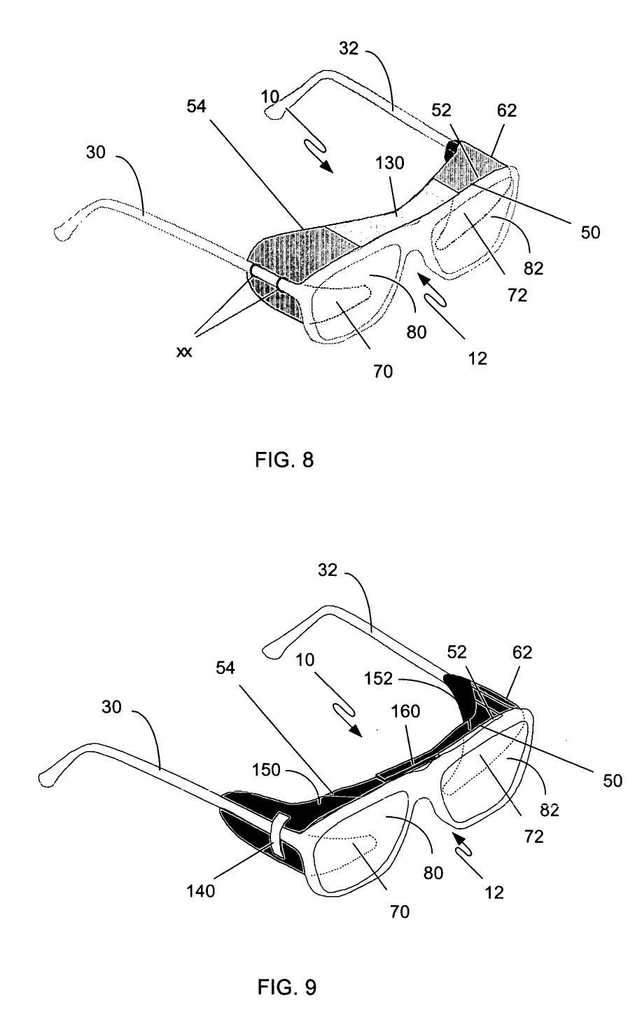

Several other means for attaching the glare shield 10 to the eyeglasses 12 are contemplated including using a tubular form having a rubberized or other similar type of lining 110 (See FIGS. 6 and 7). Still other attachment means included adjustable straps with hook-&-loop lining or one or more rubber (or other material) “O” rings 120, 122. The temple guides on certain models are synthetic rubber rings that allow the temples 30, 32 to pass through when stretched but hold tight once released keeping the glare-shield in position.

In certain other embodiments, the temple guides are plastic clips that snap onto the temples or string ties that wrap around the temple in either case affixing the glare-shield to the temple (not shown). Referring now to FIG. 9, the temple guides on certain of the models may be constructed of one or more straps 140, 142 or similar fastening means which may contain Velcro or other adjustable fastening means.

In certain embodiments, the edge of the fabric body either terminates with a hem or terminates at an edge where the hem is slightly recessed leaving a small fabric visor overhanging the edge. The hem is to maintain shape and hold the frame as well as for durability and comfort. Depending on the rigidity of the fabric the hem may contain a tape binding, a plastic insert or coated wire.

On some models of the glare-shield the fabric edges extend beyond the hem slightly so that this added visor follows the shape created by the hem. In certain preferred embodiments the glare-shield body 10 curves around peripheral viewing area following the eyeglass frame in the front and contouring to the human face all held in shape by the temple guides and flexible frame. As discussed, a small flexible over-hang of fabric furthers the reach and coverage of the glare-shield and its self-adjusting nature. This small visor fills the gap for glasses that have minor variations in the eyeglass frame shape.

There are several methods for manufacturing the glare shield 10. For example, two layers of translucent cloth may be welded together using RF technology in a specified pattern wherein a wire frame is welded into that pattern also using RF technology. In this embodiment, the width adjustment is done with an automated stitching machine which fastens mating hook & loop [Velcro] to the top of one side of the device and the bottom of the corresponding side of the device.

Other shapes and material combinations are contemplated for the design of the glare shield 10. For example, a two-part body design has the body side-pieces made up of plastic or metal and center connection area made of flexible material allowing the body to stretch and self-adjust to the eyeglass frame. In certain other embodiments an elastic material section 130 may be included to enhance the adaptability of the glare shield 10. In yet another embodiment of the present invention a pair of mirrored or similarly shaped halves 150, 152 may be joined using a number of methods such as hook & loop [Velcro] fastening 160, which would allow the glare shield to adapt to several shapes and sizes of eyewear.

In addition to the glare reducing and or blocking properties of the above-mentioned embodiments, certain embodiments of the present invention may also be employed as safety devices. For example, certain of the embodiments will prevent dust and other debris from entering into the wearer's eyes while allowing the wearer to maintain their peripheral vision.

Although the invention has been described with reference to specific embodiments, those skilled in the art will recognize that changes can be made in the form and detail without departing from the spirit and the scope of the invention. Thus, the described embodiments are to be considered in all respects only as illustrative and not restrictive.

1. A shield for limiting eye exposure to glare and debris, adapted for use with an eyewear frame having a pair of temple arms, said shield comprising a moldable structure adapted for molding to and maintaining a general shape of the eyewear frame and at least one attachment means operatively connected to said moldable structure for releasably coupling the moldable structure to at least of the temple arms.

2. The shield defined in claim 1 wherein the moldable structure further comprises a flexible material frame.

3. The shield defined in claim 2 wherein the flexible material is semitransparent.

4. The shield defined in claim 2 wherein the flexible material is opaque with perforations.

5. The shield defined in claim 2 wherein the flexible material is translucent.

6. The shield defined in claim 1 wherein the moldable structure includes a leading edge designed to follow the contours of the eyewear frame and a trailing edge designed to follow the contours of the wearer's face.

7. The shield defined in claim 2 wherein the moldable structure further includes means for molding and maintaining the shape of the shield.

8. The shield defined in claim 7 wherein the means for molding and maintaining the shape of the shield is a wire or plastic member.

9. The shield defined in claim 1 wherein the attachment means includes at least one o-ring adapted for slidably engaging a temple arm.

10. The shield defined in claim 1 wherein the attachment means includes at least one pliable tubular guide adapted for slidably engaging a temple arm.

11. The shield defined in claim 10 wherein the at least one pliable tubular guide further comprises a rubberized lining.

12. The shield defined in claim 1 wherein the attachment means includes at least one adjustable strap.

13. The shield defined in claim 1 wherein the attachment means includes at least one clip.

14. A shield for limiting eye exposure to glare and debris, adapted for use with an eyewear frame having a pair of temple arms, a pair of lenses and an outer periphery generally defined by a perimeter immediately adjacent and surrounding the pair of lenses, said shield comprising a moldable structure adapted for molding to and maintaining a general shape of said outer periphery wherein the moldable structure is designed to operatively bridge an opening between the eyewear frame and the face of the eyewear user and wherein the moldable structure further includes at least one attachment means operatively connected to said moldable structure for releasably coupling the moldable structure to the eyewear frame.

15. The shield defined in claim 14 wherein the at least one attachment means comprises a pliable tubular guide operatively constructed and positioned to slide over a temple arm.

16. The shield defined in claim 14 wherein the moldable structure further includes means for molding and maintaining the shape of the shield.

17. The shield defined in claim 16 wherein the means for molding and maintaining the shape of the shield includes a wire operatively connected to said moldable structure.

18. The shield defined in claim 14 wherein the moldable structure comprises a plurality of operatively connectable pieces adapted for providing adjustability to the shape and size of the moldable structure.

19. The shield defined in claim 18 wherein two or more of the plurality of operatively connectable pieces are connected by Velcro.

20. A universal glare and safety shield adapted for use with an eyewear frame, comprising a shapeable member adapted for molding to and maintaining a general binocular shape corresponding to the shape of the eyewear frame, the shapeable member further comprising a plurality of adjustable attachment means for removably coupling the shapeable member to the eyewear frame.
